(19) United States
(12) Patent Application Publication
(10) Pub. No.: US 2016/0023336 A1
(43) Pub. Date: Jan. 28, 2016

(54) PHASE TRANSITION HEAT STORAGE DEVICE

(71) Applicant: Taizhou Dajiang Ind. Co., Ltd., Wenling (CN)

(72) Inventors: Gui-Wen Liu, Wenling (CN); Ming-Jun Yang, Wenling (CN); Jin-Quan Huang, Wenling (CN)

(21) Appl. No.: 14/550,777

(22) Filed: Nov. 21, 2014

(30) Foreign Application Priority Data
Jul. 24, 2014 (CN) 201410354653.X
Jul. 24, 2014 (CN) 201420411806.5

(51) Int. Cl. B25C 1/04; F28D 20/00

(52) U.S. Cl. CPC B25C 1/04; F28D 20/0034

(57) ABSTRACT

The present invention relates to a phase transition heat storage device. In certain embodiments, the phase transition heat storage device includes a housing, a phase transition material body, a plurality of heating devices, a temperature sensor, and a temperature controller. The phase transition material body is disposed inside the housing. The heating devices enter the housing and are implanted inside the phase transition material body. The temperature sensor has a first end and a second end. The temperature controller is disposed outside of the housing. The first end of the temperature sensor is disposed inside the phase transition material body, and the second end of the temperature sensor is connected to the temperature controller through a first wire. The heating devices are connected to the temperature controller through a second wire. The present invention also relates to a steam powered nailing gun having a phase transition heat storage device.

### CROSS-REFERENCE TO RELATED APPLICATIONS

This application claims the priority to Chinese Patent Application Nos. 201410354653.X, and 201420411806.5, both filed on July 24, 2014, in the State Intellectual Property Office of P.R. China, which are incorporated herein in their entireties by reference.

### FIELD

The present invention mainly relates to the field of nail driving tool, and more particularly to a phase transition heat storage device and steam powered nailing guns having the phase transition heat storage device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In a conventional steam power device, burning coal or fuel gas is generally adopted to generate heat. Water is heated and vaporized by the heat generated. The high temperature vapor or steam is then used to drive steam powered tools. However, using such heat source generally requires an additional device such as a stove or a gas tank, resulting bulky size, complicated structure, low mobility, and higher transportation cost. The transportation of combustible gas powered device is also dangerous. Risk of having severe accidents is high if the combustible gas is not properly handled.

Therefore, heretofore unaddressed needs exist in the art to address the aforementioned deficiencies and inadequacies.

### SUMMARY

In one aspect, the present invention relates to a phase transition heat storage device. In certain embodiments, the phase transition heat storage device includes: a housing, a phase transition material body, a plurality of heating devices, a temperature sensor, and a temperature controller. The housing has a top surface and an opposite, bottom surface. The phase transition material body disposed inside the housing. The heating devices enter the housing and are embedded inside the phase transition material body. The temperature controller is placed outside of the housing. The temperature sensor has a first end and an opposite, second end. The first end of the temperature sensor is disposed inside the phase transition material body, and the second end of the temperature sensor is connected to the temperature controller through a first wire. The heating devices are connected to the temperature controller through a second wire.

In certain embodiments, the heating devices are embedded inside the phase transition material body. Each of the heating devices is an electric heating rod. The electric heating rod has a resistance core and a heating jacket covering an outer surface of the resistance core. Each of the heating devices has a wire connecting portion connected to one end of the resistance core.

In certain embodiments, the phase transition material body includes high thermal conductivity materials. The high thermal conductivity materials include: aluminum, lead, zinc, copper, bronze, brass, magnesium, and a combination thereof.

In certain embodiments, the housing is made of heat-resistant and corrosion resistant materials. An aerogel insulation layer is used to cover an exterior surface of the housing. The housing has a first circular opening at the center of the top surface of the housing, and a second circular opening at the center of the bottom surface of the housing, respectively.

In certain embodiments, a steam power generation device is positioned inside the housing. The steam power generation device has a first end, and an opposite, second end. The first end of the steam power generation device passes through the first circular opening on the top surface of the housing, and the second end of the steam power generation device passes through the second circular opening on the bottom surface of the housing, respectively.

In certain embodiments, a cavity is formed between the housing and the steam power generation device, and the cavity is filled with the phase transition material body. A heat receiving jacket is further disposed between the steam power generation device and the phase transition material body.

In another aspect, the present invention relates to a steam powered nailing gun. The steam powered nailing includes a phase transition heat storage device. In certain embodiments, the phase transition heat storage device includes: a housing, a phase transition material body, a plurality of heating devices, a temperature sensor, and a temperature controller. The housing has a top surface and an opposite, bottom surface. The phase transition material body disposed inside the housing. The heating devices enter the housing and are embedded inside the phase transition material body. The temperature controller is placed outside of the housing. The temperature sensor has a first end and an opposite, second end. The first end of the temperature sensor is disposed inside the phase transition material body, and the second end of the temperature sensor is connected to the temperature controller through a first wire. The heating devices are connected to the temperature controller through a second wire.

In certain embodiments, the heating devices are embedded inside the phase transition material body. Each of the heating devices is an electric heating rod. The electric heating rod has a resistance core and a heating jacket covering an outer surface of the resistance core. Each of the heating devices has a wire connecting portion connected to one end of the resistance core.

In certain embodiments, the phase transition material body includes high thermal conductivity materials. The high thermal conductivity materials include: aluminum, lead, zinc, copper, bronze, brass, magnesium, and a combination thereof.

In certain embodiments, the housing is made of heat-resistant and corrosion resistant materials. An aerogel insulation layer is used to cover an exterior surface of the housing. The housing has a first circular opening at the center of the top surface of the housing, and a second circular opening at the center of the bottom surface of the housing, respectively.

In certain embodiments, a steam power generation device is positioned inside the housing. The steam power generation device has a first end, and an opposite, second end. The first end of the steam power generation device passes through the first circular opening on the top surface of the housing, and the second end of the steam power generation device passes through the second circular opening on the bottom surface of the housing, respectively.

In certain embodiments, a cavity is formed between the housing and the steam power generation device, and the cavity is filled with the phase transition material body. A heat receiving jacket is further disposed between the steam power generation device and the phase transition material body.

The present invention provides a phase change heat storage device that has a simple structure, a compact size, low risk. It is convenient to operate, easy to transport and carry, suitable for construction work in different occasions, and desirably overcomes problems and disadvantages of other conventional devices.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention, and wherein:

FIG. 1 is a schematic structural diagram of a housing 1 of a phase transition heat storage device according to one embodiment of the present invention;

FIG. 2 is a schematic structural diagram of the phase transition heat storage device according to certain embodiments of the present invention; and

FIG. 3 is a cross-sectional structural diagram along a plane A-A shown in FIG. 2 according to certain embodiments of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximates, meaning that the term “around”, “about” or “approximately” can be inferred if not expressly stated.

Many specific details are provided in the following descriptions to make the present invention be fully understood, but the present invention may also be implemented by using other manners different from those described herein, so that the present invention is not limited by the specific embodiments disclosed in the following.

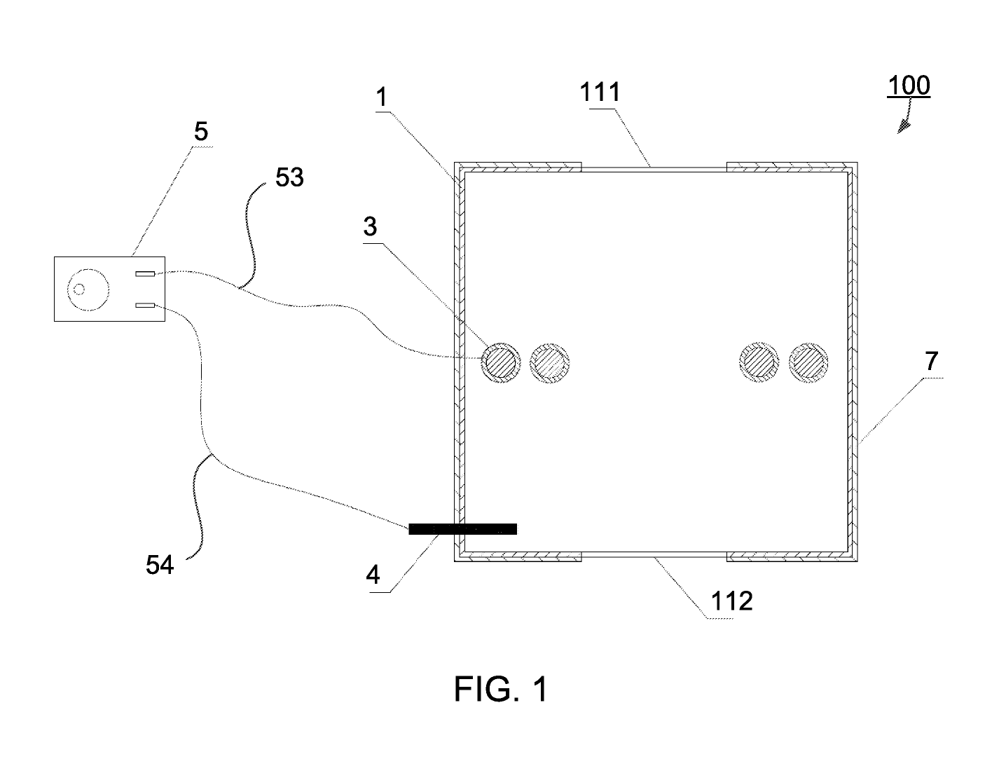

The description will be made as to the embodiments of the present invention in conjunction with the accompanying drawings FIGS. 1-3. In accordance with the purposes of this invention, as embodied and broadly described herein, this invention, in one aspect, relates to a phase transition heat storage device 100.

In certain embodiments, as shown in FIG. 1, the phase transition heat storage device 100 includes: a housing 1, a phase transition material body 2, a plurality of heating devices 3, a temperature sensor 4, and a temperature controller 5. The housing 1 has a top surface and an opposite, bottom surface. The phase transition material body 2 disposed inside the housing 1. The heating devices 3 enter the housing 1 and are embedded inside the phase transition material body 2. The temperature controller 5 is placed outside of the housing 1. The temperature sensor 4 has a first end and an opposite, second end. The first end of the temperature sensor 4 is disposed inside the phase transition material body 2, and the second end of the temperature sensor 4 is connected to the temperature controller 5 through a first wire 54. The heating devices 3 are connected to the temperature controller 5 through a second wire 53.

In certain embodiments, the phase transition material body 2 includes materials having high thermal conductivity. The materials having high thermal conductivity include: aluminum, lead, zinc, copper, bronze, brass, magnesium, and a combination thereof.

The heating devices 3, temperature sensor 4, and temperature controller 5 are used to detect the temperature changes inside the phase transition heat storage device 100, and maintain the temperature inside the phase transition heat storage device 100 at a predetermined temperature range. When the temperature sensor 4 detects that the temperature inside the phase transition heat storage device 100 falls below the predetermined temperature range, the temperature controller 5 is notified, and the temperature controller 5 controls the heating devices 3 through the second wire 53 to heat up the phase transition material body 2. When the temperature sensor 4 detects that the temperature inside the phase transition heat storage device 100 rises beyond the predetermined temperature range, the temperature controller 5 is also notified, and the temperature controller 5 turns off the heating devices 3. The temperature control of the temperature controller 5 can be operated either manually or automatically.

In certain embodiments, the housing 1 is made of heat-resistant and corrosion resistant materials. An aerogel insulation layer 7 is used to cover an exterior surface of the housing 1. The aerogel insulation layer 7 protects the heat stored inside the phase transition material body 2 from dissipation, and maintains the temperature of the phase transition material body 2 at a predetermined temperature range. In addition, the aerogel insulation layer 7 is also used to protect an operator from scalding. The housing 1 has a first circular opening 111 at the center of the top surface of the housing 1, and a second circular opening 112 at the center of the bottom surface of the housing 1, respectively.

In certain embodiments, a steam power generation device 6 is positioned inside the housing 1. The steam power generation device 6 has a first end, and an opposite, second end. The first end of the steam power generation device 6 passes through the first circular opening 111 on the top surface of the housing 1, and the second end of the steam power generation device 6 passes through the second circular opening 112 on the bottom surface of the housing 1, respectively.

In certain embodiments, a cavity is formed between the housing 1 and the steam power generation device 6, and the cavity is filled with the phase transition material body 2. A heat receiving jacket 8 is further disposed between the steam power generation device 6 and the phase transition material body 2. The heat receiving jacket 8 assists and accelerates the heat transfer from the phase transition material body 2 to the steam power generation device 6.

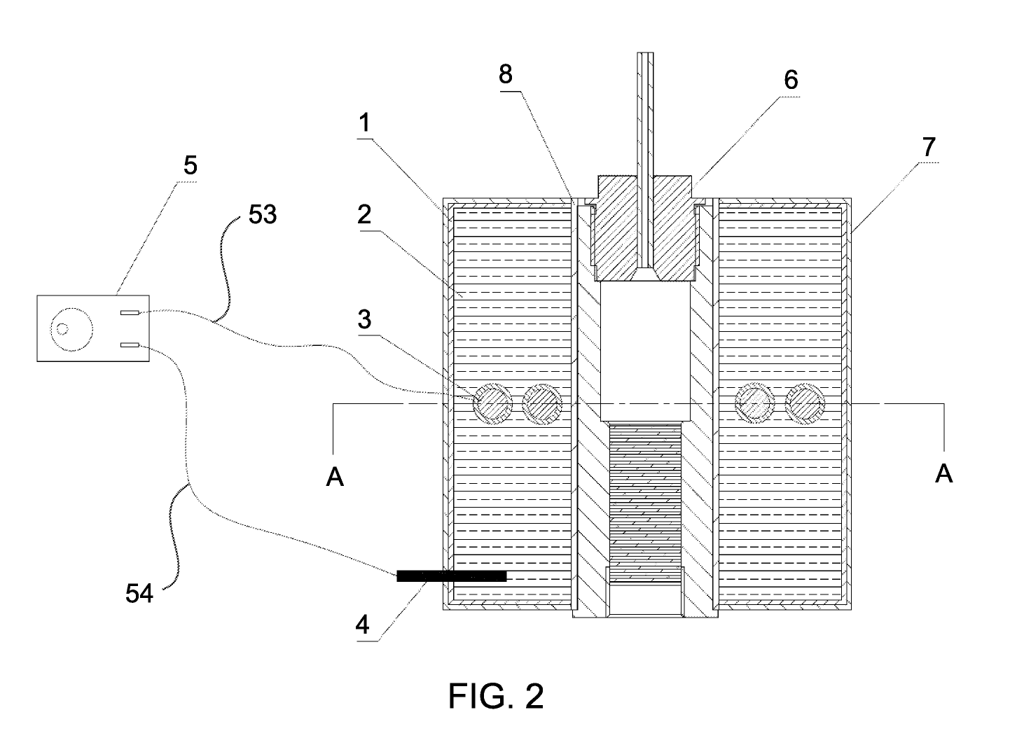

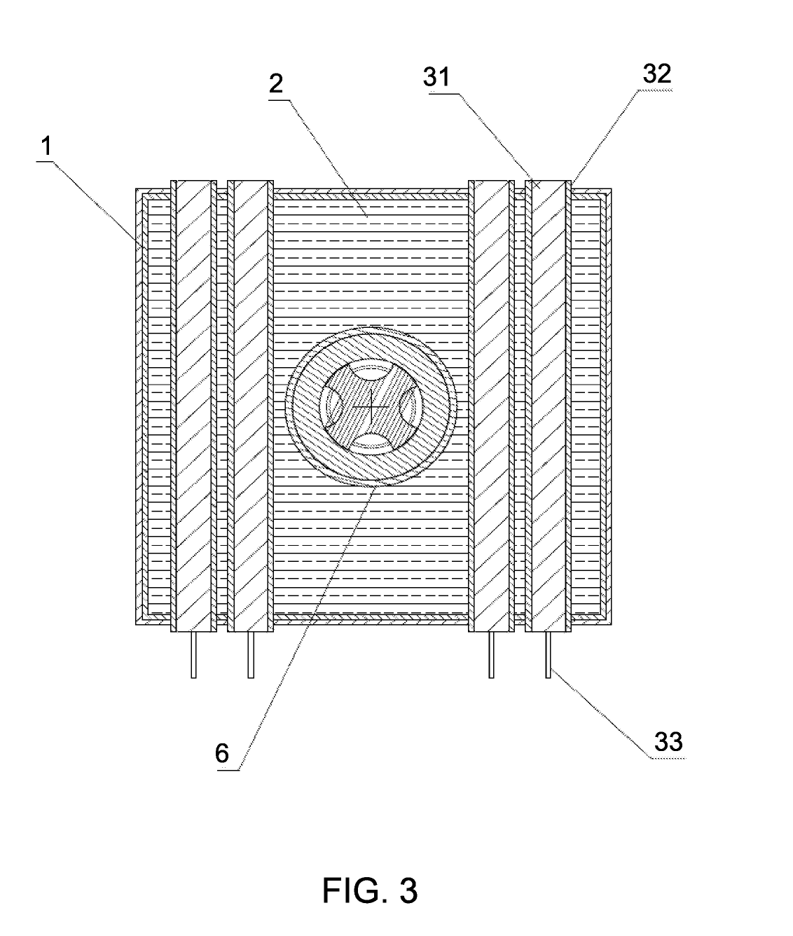

In certain embodiments, the heating devices 3 are embedded inside the phase transition material body 2. In certain embodiments, as shown in FIG. 1 and FIG. 2, the phase transition heat storage device 100 has four heating devices 3. The selection of the number of heating devices 3 to be used in a phase transition heat storage device depends on the design capacity of the phase transition heat storage device. The heating devices 3 can be more or less than four. In certain embodiments as shown in FIGS. 1-3, two heating devices 3 are installed on the left of the steam power generation device 6, and another two heating devices 3 are installed on the right of the steam power generation device 6. In one embodiment, these four heating devices 3 are placed inside the phase transition material body 2 horizontally. They are substantially perpendicular to the steam power generation device 6. As shown in FIG. 3, the heating devices 3 enters from one side of the housing 1, and exits from an opposite side, and the bodies of these heating devices 3 are embedded in the phase transition material body 2.

In certain embodiments, each of the heating devices 3 is an electric heating rod. The electric heating rod has a resistance core 31 and a heating jacket 32 covering an outer surface of the resistance core 31. Each of the heating devices 3 has a wire connecting portion 33 connected to one end of the resistance core 31 for connection to the temperature controller 5 through the second wire 53.

In certain embodiments, the operation of the phase transition heat storage device 100 is described as following:

The heating devices 3 are powered on through an external power supply and heated the phase transition material body 2. The heat generated by the heating devices 3 is transferred to the phase transition material body 2 and raised the temperature to above 400° C. Such high temperature turns the phase transition material body 2 from a solid state into a liquid state through an endothermic process, so that a large amount of heat is stored in the phase transition material body 2. When heating is stopped, the temperature of the phase transition material body 2 gradually decreases, and the phase transition material body 2 returns from the liquid state into the solid state through an exothermic process, so that released heat is transferred to the steam power generation device 6 through the heat receiving jacket 8. The steam power generation device 6 is therefore heated to generate steam to be used to drive a steam powered nailing gun.

The temperature sensor 4 is used to sense changes in temperature of the phase transition material body 2 and send an electronic signal to the temperature controller 5. Then the temperature controller 5 determines whether the phase transition material body 2 needs to be heated, and how long the phase transition material body 2 needs to be heated.

In another aspect, the present invention relates to a steam powered nailing gun. The steam powered nailing includes a phase transition heat storage device 100. In certain embodiments, the phase transition heat storage device 100 includes: a housing 1, a phase transition material body 2, a plurality of heating devices 3, a temperature sensor 4, and a temperature controller 5. The housing 1 has a top surface and an opposite, bottom surface. The phase transition material body 2 disposed inside the housing 1. The heating devices 3 enter the housing 1 and are embedded inside the phase transition material body 2. The temperature controller 5 is placed outside of the housing 1. The temperature sensor 4 has a first end and an opposite, second end. The first end of the temperature sensor 4 is disposed inside the phase transition material body 2, and the second end of the temperature sensor 4 is connected to the temperature controller 5 through a first wire 54. The heating devices 3 are connected to the temperature controller 5 through a second wire 53.

In certain embodiments, the heating devices 3 are embedded inside the phase transition material body 2. Each of the heating devices 3 is an electric heating rod. The electric heating rod has a resistance wire 31 and a heating jacket 32 covering an outer surface of the resistance wire 31. Each of the heating devices 3 has a wire connecting portion 33 connected to one end of the resistance wire 31.

In certain embodiments, the phase transition material body 2 includes high thermal conductivity materials. The high thermal conductivity materials include: aluminum, lead, zinc, copper, bronze, brass, magnesium, graphite, tungsten, graphene, and a combination thereof.

In certain embodiments, the housing 1 is made of heat-resistant and corrosion resistant materials. An aerogel insulation layer is used to cover an exterior surface of the housing 1. The housing 1 has a first circular opening 111 at the center of the top surface of the housing 1, and a second circular opening 112 at the center of the bottom surface of the housing 1, respectively.

In certain embodiments, a steam power generation device 6 is positioned inside the housing 1. The steam power generation device 6 has a first end, and an opposite, second end. The first end of the steam power generation device 6 passes through the first circular opening 111 on the top surface of the housing 1, and the second end of the steam power generation device 6 passes through the second circular opening 112 on the bottom surface of the housing 1, respectively.

In certain embodiments, a cavity is formed between the housing 1 and the steam power generation device 6, and the cavity is filled with the phase transition material body 2. A heat receiving jacket 8 is further disposed between the steam power generation device 6 and the phase transition material body 2.

The present invention uses high pressure steam as a power source, ordinary liquid water is turned into high pressure steam to drive a piston mechanism to work, and drive a firing pin to drive a nail into an object. As steam is used as a power source, compared with air compression, electrical power supply, rechargeable batteries or gases, the steam powered nailing gun has a compact size, light weight, low cost, and is easy to carry and transport and safe and reliable to use. It may effectively save the cost for enterprises, and improve economic efficiency of the enterprises.

The power supply required in the present invention may be a domestic or industrial alternating current, or may be provided by a rechargeable battery.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims, the foregoing description and the exemplary embodiments described therein, and accompanying drawings.

What is claimed is:

1. A phase transition heat storage device, comprising:
a housing having a top surface and an opposite, bottom surface;
a phase transition material body disposed inside the housing;
a plurality of heating devices passing through the housing and embedded inside the phase transition material body;
a temperature sensor having a first end and an opposite, second end; and
a temperature controller disposed outside of the housing, wherein the first end of the temperature sensor is disposed inside the phase transition material body, the second end of the temperature sensor is connected to the temperature controller through a first wire, and the plurality of heating devices is connected to the temperature controller through a second wire.

2. The phase transition heat storage device according to claim 1, wherein the plurality of heating devices is embedded inside the phase transition material body, each of the plurality of heating devices is an electric heating rod comprising a resistance core and a heating jacket covering an outer surface of the resistance core, and each of the plurality of heating devices has a wire connecting portion connected to one end of the resistance core.

3. The phase transition heat storage device according to claim 1, wherein the phase transition material body comprises high thermal conductivity materials.

4. The phase transition heat storage device according to claim 3, wherein the high thermal conductivity materials comprise: aluminum, lead, zinc, copper, bronze, brass, magnesium, and a combination thereof.

5. The phase transition heat storage device according to claim 1, wherein the housing comprises a heat-resistant and corrosion resistant material.

6. The phase transition heat storage device according to claim 1, wherein an aerogel insulation layer 7 is further covered on an exterior surface of the housing.

7. The phase transition heat storage device according to claim 1, wherein the housing has a first circular opening at the center of the top surface of the housing, and a second circular opening at the center of the bottom surface of the housing, respectively.

8. The phase transition heat storage device according to claim 7, wherein a steam power generation device having a first end, and an opposite, second end, is disposed inside the housing, wherein the first end of the steam power generation device passes through the first circular opening on the top surface of the housing, and the second end of the steam power generation device passes through the second circular opening on the bottom surface of the housing, respectively.

9. The phase transition heat storage device according to claim 8, further comprising a cavity between the housing and the steam power generation device, wherein the cavity is filled with the phase transition material body.

10. The phase transition heat storage device according to claim 9, wherein a heat receiving jacket is further disposed between the steam power generation device and the phase transition material body.

11. A steam powered nailing gun comprising a phase transition heat storage device, wherein the phase transition heat storage device comprises:
a housing having a top surface and an opposite, bottom surface;
a phase transition material body disposed inside the housing;
a plurality of heating devices passing through the housing and embedded inside the phase transition material body;
a temperature sensor having a first end and an opposite, second end; and
a temperature controller disposed outside of the housing, wherein the first end of the temperature sensor is disposed inside the phase transition material body, the second end of the temperature sensor is connected to the temperature controller through a first wire, and the plurality of heating devices is connected to the temperature controller through a second wire.

12. The steam powered nailing gun according to claim 11, wherein the plurality of heating devices is embedded inside the phase transition material body, each of the plurality of heating devices is an electric heating rod comprising a resistance core and a heating jacket covering an outer surface of the resistance core, and a wire connecting portion is disposed at one end of the resistance core.

13. The steam powered nailing gun according to claim 11, wherein the phase transition material body comprises high thermal conductivity materials.

14. The steam powered nailing gun according to claim 13, wherein the high thermal conductivity materials comprise: aluminum, lead, zinc, copper, bronze, brass, magnesium, and a combination thereof.

15. The steam powered nailing gun according to claim 11, wherein the housing comprises a heat-resistant and corrosion resistant material.

16. The steam powered nailing gun according to claim 11, wherein an aerogel insulation layer is further covered on an exterior surface of the housing.

17. The steam powered nailing gun according to claim 11, wherein the housing has a first circular opening at the center of the top surface of the housing, and a second circular opening at the center of the bottom surface of the housing, respectively.

18. The steam powered nailing gun according to claim 17, wherein a steam power generation device is disposed inside the housing, wherein a first end of the steam power generation device passes through the first circular opening on the top surface of the housing, and a second end of the steam power generation device passes through the second circular opening on the bottom surface of the housing, respectively.

19. The steam powered nailing gun according to claim 18, further comprising a cavity between the housing and the steam power generation device, wherein the cavity is filled with the phase transition material body.

20. The steam powered nailing gun according to claim 19, wherein a heat receiving jacket is further disposed between the steam power generation device and the phase transition material body.
